(19) United States
(12) Patent Application Publication
(10) Pub. No.: US 2024/0380060 A1
(43) Pub. Date: Nov. 14, 2024

(54) BATTERY CELL INCLUDING PROTECTIVE FILM AND METHOD OF MANUFACTURING BATTERY CELL INCLUDING PROTECTIVE FILM

(71) Applicant: SK On Co., Ltd., Seoul (KR)

(72) Inventors: Seung Hyeon CHEON, Daejeon (KR); Sung Yeop KIM, Daejeon (KR)

(21) Appl. No.: 18/650,112

(22) Filed: Apr. 30, 2024

(30) Foreign Application Priority Data
May 9, 2023 (KR) 10-2023-0059580

(51) Int. Cl. H01M 50/342; H01M 10/04; H01M 50/367

(52) U.S. Cl. CPC H01M 50/3425; H01M 50/367; H01M 10/0481; H01M 2200/20

(57) ABSTRACT

A battery cell is disclosed. In some implementations, the battery cell may include an electrode assembly, a case configured to accommodate the electrode assembly, a venting portion coupled to the case, the venting portion configured to provide an exhaust path for gas generated in the electrode assembly, and a protective film attached to the case, the protective film configured to cover at least a portion of the venting portion. The protective film may include a breakable portion including a plurality of recess regions spaced apart from each other.

### CROSS-REFERENCE TO RELATED APPLICATION(S)

This patent document claims the priority and benefits of Korean Patent Application No. 10-2023-0059580 filed on May 9, 2023, the disclosure of which is incorporated herein by reference in its entirety.

### TECHNICAL FIELD

The present disclosure relates to a battery cell including a protective film and a method of manufacturing the battery cell including the protective film.

### BACKGROUND

Unlike primary batteries, secondary batteries may be charged and discharged, and thus may be applied to devices within various fields such as digital cameras, mobile phones, laptops, and hybrid vehicles. Secondary batteries include nickel-cadmium batteries, nickel-metal hydride batteries, nickel-hydrogen batteries, lithium secondary batteries, and the like.

Lithium secondary batteries have been manufactured as pouch-type battery cells having flexibility, prismatic battery cells having rigidity, or cylindrical can-type battery cells. A plurality of battery cells may be stacked to form a cell assembly.

The cell stack may be accommodated in a module housing to form a battery module. In addition, a plurality of battery modules may be accommodated in a pack housing to form a battery pack.

### SUMMARY

Gas may be generated in an electrode assembly positioned in a battery cell. When gas released from the battery cell is transferred to other battery cells or other components, heat transfer may occur, or the other components may be damaged. Accordingly, the battery cell may include a venting portion configured to form a path for gas generated in the electrode assembly to be discharged. At least a portion of the venting portion may break when an internal pressure of a case is higher than or equal to a predetermined pressure, thereby allowing gas generated in a secondary battery to be externally discharged.

In addition, to insulate the case of the battery cell, the battery cell may include a protective film surrounding at least a portion of an external surface of the battery cell. However, the protective film may hinder gas, discharged from the venting portion, from being discharged.

In addition, the venting portion may have a protruding surface. The protruding surface of the venting portion may reduce coupling force between the protective film and the venting portion.

The present disclosure can be implemented in some embodiments to provide a battery cell including a protective film having a reduced degree of detachment from a venting portion of the battery cell.

The present disclosure can be implemented in some embodiments to provide a battery cell including a protective film for smooth discharge of venting gas.

The present disclosure can be implemented in some embodiments to provide a battery cell including a protective film that is breakable with high reliability within a preset pressure range for breaking.

A battery cell including a protective film and a method of manufacturing the battery cell including the protective film according to the present disclosure may be widely applied in the field of green technology, such as electric vehicles, battery charging stations, and other battery-utilizing solar power generation schemes, wind power generation schemes, or the like. In addition, a battery cell including a protective film and a method of manufacturing the battery cell including the protective film of the present disclosure may be used in eco-friendly electric vehicles, hybrid vehicles, and the like, to prevent climate change by suppressing air pollution and greenhouse gas emissions.

In some embodiments of the present disclosure, a battery cell may include an electrode assembly, a case accommodating the electrode assembly, a venting portion coupled to the case, the venting portion configured to provide an exhaust path for gas generated in the electrode assembly, and a protective film attached to the case, the protective film configured to cover at least a portion of the venting portion. The protective film may include a breakable portion including a plurality of recess regions spaced apart from each other.

The venting portion may include a base coupled to the case, and a notch portion formed on the base, the notch portion configured to break at a specified pressure or higher.

The plurality of recess regions may oppose at least a portion of the notch portion.

The breakable portion may have a non-cutting region positioned between the plurality of recess regions. A first length of the recessed region may be greater than a second length of the non-cutting region.

The breakable portion may be configured to break due to the gas.

The case may have a first opening oriented in a first direction, and a second opening oriented in a second direction, opposite to the first direction. The battery cell may further include a first cap assembly sealing the first opening, the first cap assembly including a first electrode terminal connected to a cathode of the electrode assembly, and a second cap assembly sealing the second opening, the second cap assembly including a second electrode terminal connected to an anode of the electrode assembly.

The venting portion may be positioned between the first cap assembly and the second cap assembly.

The case may have a first side surface and a second side surface having a width, greater than that of the first surface. At least a portion of the venting portion may be disposed in a through-hole formed in the first side surface. The protective film may include an insulating tape.

The breakable portion may have a first breakable region extending in a longitudinal direction of the case, a second breakable region extending from one end of the first breakable region in a width direction of the case, and a third breakable region extending from the other end of the first breakable region in the width direction of the case.

The breakable portion may have a first end regions extending from opposite ends of the second breakable region in a second direction, parallel to the longitudinal direction of the case, and a second end region extending from opposite ends of the third breakable region in a first direction, opposite to the second direction.

The plurality of recess regions may be arranged to have a shape of a dotted line or a dashed line.

In some embodiments of the present disclosure, a battery device may comprise a battery cell, and a frame accommodating the battery cell. The battery cell includes an electrode assembly, a case accommodating the electrode assembly, a venting portion coupled to the case, the venting portion configured to provide an exhaust path for gas generated in the electrode assembly, and a protective film attached to the case, the protective film configured to cover at least a portion of the venting portion. The protective film includes a breakable portion including a plurality of recess regions spaced apart from each other.

In some embodiments of the present disclosure, a method of manufacturing a battery device, the method may include an operation of preparing a protective film including a breakable portion, an operation of moving the protective film onto a case of the battery cell, an operation of pressing the protective film, and an operation of heating the protective film.

The operation of moving the protective film may be configured to move the protective film such that the breakable portion opposes at least a portion of a notch portion formed in a venting portion of the battery cell.

The operation of pressing the protective film may include a first rolling operation of pressing a portion of the protective film, opposing the venting portion of the battery cell, in a width direction of the case, a second rolling operation of pressing a portion of the protective film, opposing the venting portion of the battery cell, in a longitudinal direction of the case, and a third rolling operation of pressing another portion of the protective film, disposed on the case without opposing the venting portion of the battery cell, in the width direction of the case.

According to an embodiment of the present disclosure, a degree of detachment of a protective film from a venting portion may be reduced, or the protective film may be prevented from being detached from the venting portion.

According to an embodiment of the present disclosure, resistance of gas, released from the venting portion, to the protective film may be reduced.

According to an embodiment of the present disclosure, the protective film may break with high reliability within a specific preset pressure range.

### BRIEF DESCRIPTION OF DRAWINGS

Certain aspects, features, and advantages of the present disclosure are illustrated by the following detailed description with reference to the accompanying drawings.

FIG. 1 is a perspective view of a battery cell, according to an embodiment.

FIG. 2 is an exploded perspective view of a battery cell, according to an embodiment.

FIG. 3 is a cross-sectional view of a battery cell taken along line I-I′ of FIG. 1, according to an embodiment.

FIG. 4 is an enlarged view of region A of FIG. 1, according to an embodiment.

FIG. 5 is a front view of a cover region of a protective film, according to an embodiment.

FIGS. 6A to 6C are a front view of a protective film, according to various embodiments.

FIG. 7 is a flowchart of a method of manufacturing a battery cell, according to an embodiment.

FIG. 8 is an exploded perspective view of a battery device, according to an embodiment.

### DETAILED DESCRIPTION

Features of the present disclosure disclosed in this patent document are described by example embodiments with reference to the accompanying drawings. However, the features are merely exemplary, and the present disclosure is not limited to the specific embodiments described herein. The words and terminologies used in the specification

and claims should not be construed with common or dictionary meanings, but construed as meanings and conception coinciding the spirit of the present disclosure under a principle that the inventor(s) can appropriately define the conception of the terminologies to explain the present disclosure in the optimum method.

Therefore, embodiments described in the specification and the configurations illustrated in the drawings are not more than the most preferred embodiments of the present disclosure and do not fully cover the spirit of the present disclosure. Accordingly, it should be understood that there may be various equivalents and modifications that can replace those when the present application is filed.

Hereinafter, preferred embodiments of the present disclosure will be described in detail with reference to the accompanying drawings. In this case, it should be noted that the same components are denoted by the same reference numerals in the accompanying drawings. In addition, detailed descriptions of well-known functions and configurations that may obscure the gist of the present disclosure will be omitted. In addition, some components are exaggerated, omitted, or schematically illustrated in the accompanying drawings, and the size of each component does not fully reflect the actual size.

The present disclosure can be implemented in some embodiments to provide a battery cell including a protective film and a method of manufacturing the battery cell including the protective film.

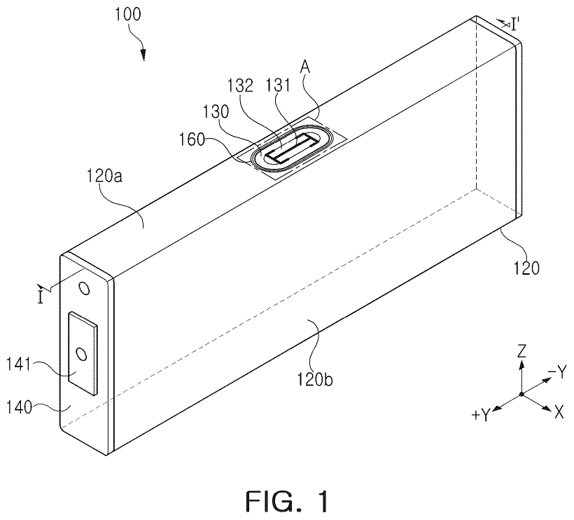

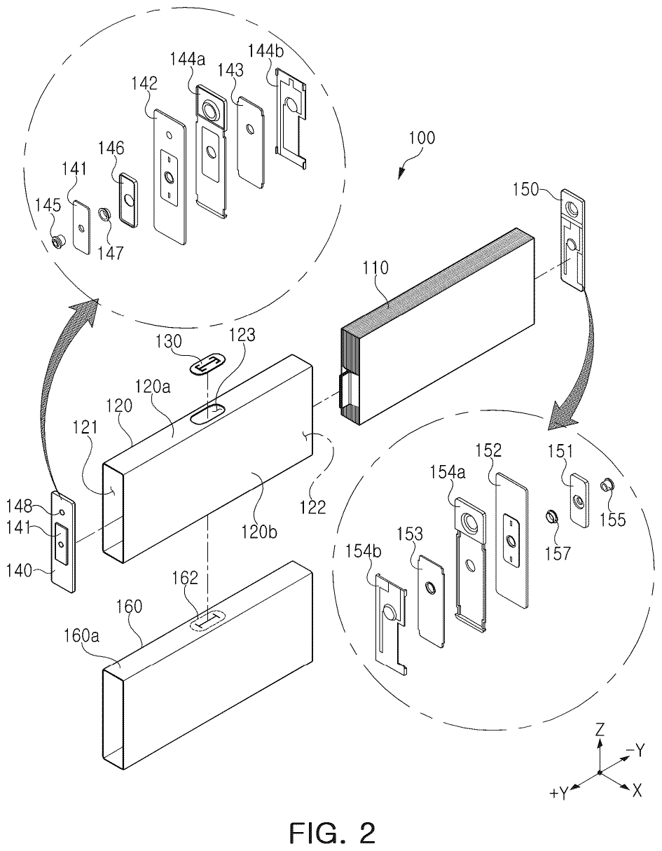

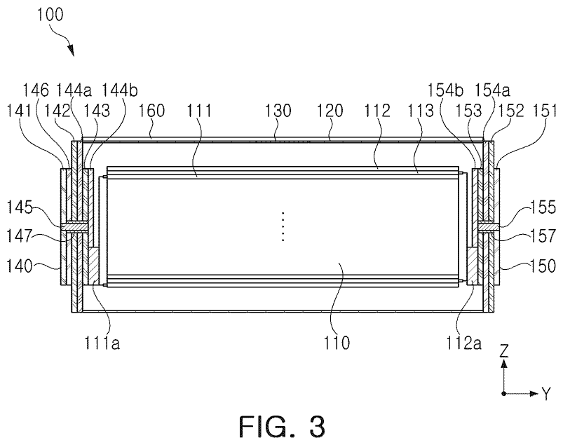

FIG. 1 is a perspective view of a battery cell, according to an embodiment. FIG. 2 is an exploded perspective view of a battery cell, according to an embodiment. FIG. 3 is a cross-sectional view of a battery cell taken along line I-I′ of FIG. 1, according to an embodiment.

Referring to FIGS. 1, 2, and/or 3, a battery cell 100 may be a prismatic secondary battery cell. For example, the battery cell 100 may be a lithium-ion battery or a nickel metal hydride battery capable of being charged and discharged. The battery cell 100 may include an electrode assembly 110, a case 120, a venting portion 130, cap assemblies 140 and 150, and/or a protective film 160.

The electrode assembly 110 may include a first electrode plate 111, a second electrode plate 112, and a separator 113. The first electrode plate 111 may be a cathode plate, and the second electrode plate 112 may be an anode plate. The separator 113 may prevent contact between the first electrode plate 111 and the second electrode plate 112. For example, the separator 113 may be an insulator positioned between the first electrode plate 111 and the second electrode plate 112.

A structure of the electrode assembly 110 may be selectively designed. In an embodiment, the electrode assembly 110 may be a jelly roll-type electrode assembly in which the first electrode plate 111, the second electrode plate 112, and at least one separator 113 are wound together. In an embodiment, the electrode assembly 110 may be a Z-fold type electrode assembly including the separator 113 folded a plurality of times. In an embodiment, the electrode assembly 110 may be a stack-type electrode assembly in which the first electrode plate 111, the second electrode plate 112, and one of a plurality of separators 113 are alternately stacked.

The case 120 may forms at least a portion of the exterior of the battery cell 100, and may accommodate the electrode assembly 110. For example, the case 120 may provide a space in which the electrode assembly 110 and an electrolyte are accommodated. According to an embodiment, the case 120 may include aluminum. The case 120 may be referred to as a can or housing. The case 120 may have a substantially rectangular parallelepiped shape with at least a portion of the case 120 open. For example, the case 120 may include a first side surface 120a and a second side surface 120b having a width, greater than a width of the first side surface 120a. The first side surface 120a may be referred to as a narrow side surface, and the second side surface 120b may be referred to as a wide side surface.

According to an embodiment, the case 120 may have a first opening 121 formed in one side thereof (+Y-direction) in a longitudinal direction (Y-axis direction) of the battery cell 100, a second opening 122 formed in the other side thereof (−Y-direction) in the longitudinal direction, and a through-hole 123 formed in a height (Z-axis direction) of the battery cell 100. The first opening 121, the second opening 122, and the through-hole 123 may be respectively an empty space connected to an internal space of the case 120.

The cap assemblies 140 and 150 may be respectively coupled to opposite sides of the case 120 in the longitudinal direction (for example, the Y-axis direction). For example, the cap assemblies 140 and 150 may accommodate the electrode assembly 110 and the electrolyte, together with the case 120. The cap assemblies 140 and 150 may include a first cap assembly 140 coupled to an end of the case 120 in a first direction (+Y-direction), and a second cap assembly 150 coupled to an end of the case in a second direction (−Y-direction), opposite to the first direction (+Y-direction). The first cap assembly 140 may seal the first opening 121 of the case 120. The second cap assembly 150 may seal the second opening 122 of the case 120.

The cap assemblies 140 and 150 may include a plurality of components.

In an embodiment, the cap assemblies 140 and 150 may include cap plates 142 and 152 coupled to the case 120, the cap plates 142 and 152 sealing the case 120. For example, the cap plates 142 and 152 may be formed of aluminum or a material including aluminum. The cap plates 142 and 152 may be laser-welded to the case 120 along an edge portion thereof. When the cap plates 142 and 152 are coupled to the case 120, the inside of the case 120 may be sealed, such that at least one of the cap plates 142 and 152 may include an electrolyte injection port 148 to inject an electrolyte into the case. The electrolyte injection port 148 may be sealed with a stopper or the like after the electrolyte is injected.

The cap assemblies 140 and 150 may include terminal plates 141 and 151. The terminal plates 141 and 151 may be coupled to one surfaces of the cap plates 142 and 152. The one surfaces of the cap plates 142 and 152 may be opposite to a surface toward the inside of the case 120. When a module or pack is formed, the battery cell 100 may be electrically connected to an adjacent battery cell 100 through the terminal plates 141 and 151.

The terminal plates 141 and 151 may have a positive or negative polarity. For example, based on the drawings, a first terminal plate 141 disposed in the first direction (+Y-direction) of the case 120 may have a negative polarity, and a second terminal plate 151 disposed in the second direction (−Y-direction) of the case 120 may have a positive polarity. For example, the first terminal plate 141 may be electrically connected to the first electrode plate 111 through a first electrode tab 111a. The second terminal plate 151 may be electrically connected to the second electrode plate 112 through a second electrode tab 112a.

In an embodiment, the terminal plates 141 and 151 may be disposed on the cap plates 142 and 152, such that an insulating plate (external insulating plate) 146 may be disposed between a terminal plate (for example, the first terminal plate 141) having a negative polarity and the first cap plate 142.

Current collector plates 143 and 153 may be disposed on the other surfaces of the cap plates 142 and 152. The current collector plates 143 and 153 may be respectively connected to an electrode tab portion of the first electrode plate 111 or the second electrode plate 112 of the electrode assembly 110, and may have a positive or negative polarity. Insulating plates (internal insulating plates) 144a, 144b, 154a, and 154b may be respectively disposed between the cap plates 142 and 152 and the current collector plates 143 and 153 and between the current collector plates 143 and 153 and an internal space of the case 120.

According to an embodiment, the cap assemblies 140 and 150 may include rivet terminals 145 and 155 passing in a thickness direction from the terminal plates 141 and 151 to the current collector plates 143 and 153. To this end, the cap plates 142 and 152, the terminal plates 141 and 151, the current collectors 143 and 153, and some insulating plates 144a and 154a may include holes into which the rivet terminals 145 and 155 are inserted. Gaskets 147 and 157 may be fitted between the holes and the rivet terminals 145 and 155.

The components of the cap assemblies 140 and 150 described above are merely an example embodiment. Thus, some of the components of the cap assemblies 140 and 150 may be omitted or other components, not described herein, may be added.

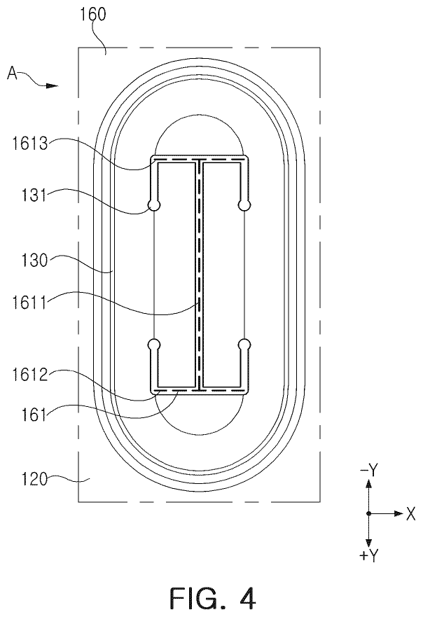

The venting portion 130 may provide a path for discharging gas generated in the case 120 to the outside of the case 120. For example, the venting portion 130 may include a notch portion (for example, a notch portion 131 in FIG. 4) configured to break at a specified pressure or higher, and a base 132 coupled to the case 120.

According to an embodiment, the venting portion 130 may be positioned on the first side surface 120a of the case 120 having a relatively large stress value, among remaining surfaces of the case 120 excluding a portion of the case 120 to which the cap assemblies 140 and 150 are coupled. The venting portion 130 may be positioned between the first cap assembly 140 and the second cap assembly 150. According to an embodiment, at least a portion of the venting portion 130 may be disposed in the through-hole 123 formed in the first side surface 120a.

The venting portion 130 according to the related art may be positioned on the cap assembly 140 and 150. However, when the venting portion 130 is formed on the first side surface 120a of the case 120, as in this patent document, a degree of design freedom may be improved at a battery module or battery pack level.

In addition, as in an embodiment, in the battery cell 100 including a plurality of cap assemblies 140 and 150 positioned on opposite sides of the case 120 in the longitudinal direction, a space available for one cap assembly 140 or 150 may be reduced. The venting portion 130 may be formed in the case 120, thereby improving a degree of design freedom of the venting portion 130 and improving discharge of internal gas of the case 120.

According to an embodiment, the base 132 may be welded and coupled to the case 120 along an edge portion thereof. The base 132 may be a plate including aluminum.

According to an embodiment, the notch portion 131 may be a recess, groove, and/or hole formed in the base 132. The notch portion 131 may be a portion of the venting portion 130 breaking before other portions of the venting portion 130, when an internal pressure of the case 120 is higher than or equal to a predetermined pressure. A thickness of at least a portion of the notch portion 131 may be less than a thickness of the base 132.

At least a portion of gas generated in the case 120 may be discharged through an empty space of the venting portion 130, formed when the notch portion 131 breaks. Thus, a direction in which gas is discharged may be controlled from the perspective of the battery cell 100.

The protective film 160 may be used to insulate the case 120 of the battery cell 100. For example, the protective film 160 may include an insulating material. The protective film 160 may be referred to as a protective member, a protective tape, an insulating film, an insulating member, and/or an insulating tape. According to an embodiment, the protective film 160 may include an adhesive material for coupling to the case 120 and the venting portion 130.

The protective film 160 may cover at least a portion of the case 120. In this patent document, the protective film 160 is illustrated as covering the entire case 120. However, a position in which the protective film 160 covers the case 120 may be changed depending on the design. For example, in an embodiment, the protective film 160 may cover the venting portion 130 and at least a portion of the first side surface 120a of the case 120. According to an embodiment, at least a portion of the protective film 160 may be folded to overlap one another.

According to an embodiment, a cover region 162 of the protective film 160 may cover the venting portion 130. At least a portion (for example, the cover region 162) of the protective film 160 may be in contact with at least a portion of venting gas passing through the notch portion 131, after the notch portion 131 of the venting portion 130 breaks. A path for gas discharged from the venting portion 130 may be changed due to the cover region 162.

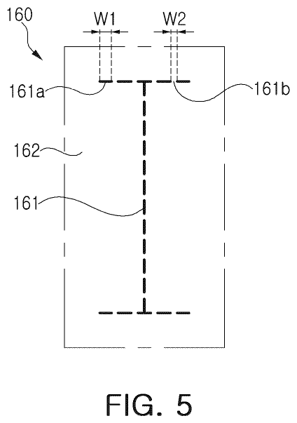

FIG. 4 is an enlarged view of region A of FIG. 1, according to an embodiment. FIG. 5 is a front view of a cover region of a protective film, according to an embodiment. Referring to FIGS. 4 and/or 5, a venting portion 130

may be coupled to a case 120. A protective film 160 may cover the venting portion 130 and at least a portion of the case 120. The description of the case 120, the venting portion 130, and the protective film 160 in FIGS. 1, 2, and/or 3 may be applied to the case 120, the venting portion 130, the protective film 160 in FIGS. 4 and/or 5.

The protective film 160 may cover the venting portion 130, together with at least a portion of the case 120. The protective film 160 may cover the venting portion 130, thereby increasing insulation of a battery cell 100. For example, when the protective film 160 has a hole through which the venting portion 130 is exposed, insulation may be reduced due to exposure of the venting portion 130. The protective film 160 in this patent document may cover the venting portion 130, and may not restrict a path for venting gas passing through the venting portion 130 using a breakable portion 161.

The protective film 160 may include the breakable portion 161. The breakable portion 161 may be a portion of the protective film 160 breaking before other portions of the protective film 160, when an internal pressure of the case 120 is higher than or equal to a predetermined pressure. An average thickness of the breakable portion 161 may be less than an average thickness of the protective film 160. According to an embodiment, the breakable portion 161

may substantially have a shape of a dotted line or dashed line. According to an embodiment, the breakable portion 161 may have a plurality of recess regions 161a spaced apart from each other, and a non-cutting region 161b. The plurality of recess regions 161a may be arranged to have a shape of a dotted line or dashed line.

The recess region 161a may be a groove, a hole, a valley, and/or a pattern formed in the protective film 160. The non-cutting region 161b may be a portion of the protective film 160 positioned between the plurality of recess regions 161a. The recess region 161a may be referred to as a cutting region. However, the recess region 161a may not be formed to have a shape of a through-hole. The recess region 161a may be formed using pressing using a mold or laser processing.

According to an embodiment, a depth of the recess region 161a may be selectively designed. For example, the recess region 161a may be cut to have a depth for maintaining insulation. In an embodiment, the depth of the recess region 161a may be 10% of a thickness of the protective film 160.

The breakable portion 161 may have a non-cutting region 161b positioned between the plurality of recess regions 161a spaced apart from each other. Thus, in the cover region 162 of the protective film 160, a contact area between the protective film 160 and the venting portion 130 may increase, thereby increasing coupling force between the protective film 160 and the venting portion 130. For example, the venting portion 130 may have a protruding surface or recessed surface, and the protective film 160 may be modified to have a shape corresponding to a surface shape of the venting portion 130. The coupling force between the protective film 160 and the venting portion 130 may be increased, thereby reducing a degree of detachment of the protective film 160 and reducing exterior defects.

According to an embodiment, a shape of the breakable portion 161 may be selectively designed depending on a structure of a battery cell (for example, the battery cell 100 in FIG. 1). For example, a proportion of a first length W1 of the recess region 161a to a second length W2 of the non-cutting region 161b may be selectively designed in consideration of an insulation value of the protective film 160 and/or coupling force between the protective film 160 and the venting portion 130. In an embodiment, the first length of the recess region 161a may be greater than the second length of the non-cutting region 161b.

According to an embodiment, a sum of the first lengths W1 of the recess regions 161a may be greater than or equal to a sum of the second lengths W2 of the non-cutting regions 161b. As a proportion of the recess region 161a in the breakable portion 161 increases, venting gas generated in the electrode assembly 110 may be easily discharged through the breakable portion 161. In an embodiment, the first length W1 may be about twice the second length W2.

In an embodiment, the breakable portion 161 may be formed to correspond to at least a portion of the notch portion 131. For example, at least a portion of the breakable portion 161 and at least a portion of the notch portion 131 may oppose each other. As the recess region 161a of the breakable portion 161 opposes the notch portion 131, coupling force of the protective film 160 to the venting portion) may be increased, and resistance to the protective film 160 may be reduced when internal venting gas of the case 120 is released.

In an embodiment, the breakable portion 161 may be formed to have an overall shape similar to a shape of the letter “I.” For example, the breakable portion 161 may have a first breakable region 1611 extending in a first direction, parallel to a longitudinal direction (Y-axis direction) of the case 120. The breakable portion 161 may have a second breakable region 1612 extending from one end of the first breakable region 1611 in a third direction (for example, an X-axis direction), perpendicular to the first direction, and a third breakable region 1613 extending from the other end of the first breakable region 1611 in the third direction (X-axis direction).

A shape of the notch portion 131 of the venting portion 130 is not limited to the structure illustrated in FIG. 4. For example, the shape of the notch portion 131 may be selectively designed, as long as the notch portion 131 has a structure for discharging gas generated in an electrode assembly (for example, the electrode assembly 110 in FIG. 2) to the outside of the case 120.

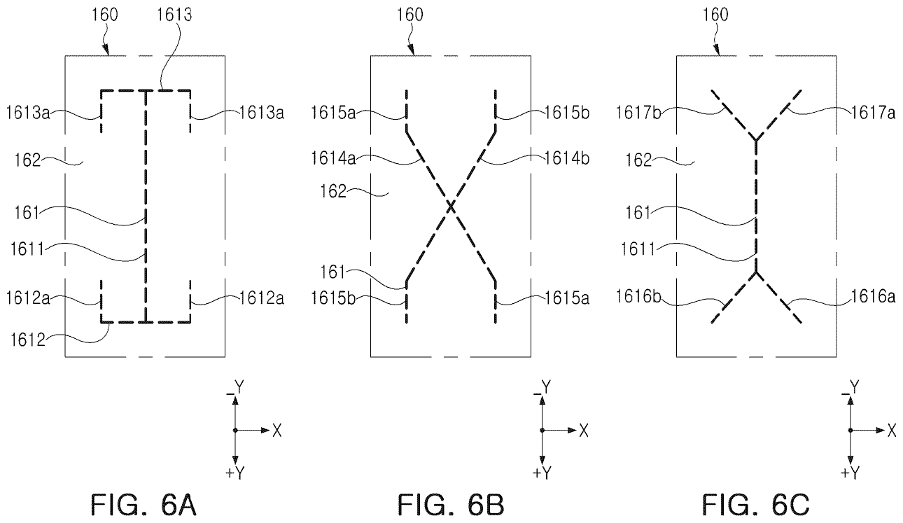

FIGS. 6A to 6C are a front view of a protective film, according to various embodiments.

The description of the protective film 160 in FIGS. 1 to 5 may be applied to a protective film 160 in FIG. 6. For example, the protective film 160 may have a cover region 162 covering a venting portion (for example, the venting portion 130 in FIG. 1), and a breakable portion 161 formed in the cover region 162.

Referring to FIGS. 6A to 6C, a shape of the protective film 160 may be selectively designed.

Referring to FIG. 6A, the protective film 160 may have a modified shape of the letter “I”. For example, the breakable portion 161 may have a first breakable region 1611 extending in a longitudinal direction (Y-axis direction) of a case (for example, the case 120 in FIG. 1), a second breakable region 1612 extending from one end of the first breakable region 1611 in a third direction (for example, an X-axis direction), perpendicular to a first direction (+Y-direction) or a second direction (−Y-direction), and a third breakable region 1613 extending from the other end of the first breakable region 1611 in the third direction (X-axis direction). The breakable portion 161 may have a first end region 1612a extending from opposite ends of the second breakable region 1612 in the second direction (−Y-direction), and a second end region 1613a extending from opposite ends of the third breakable region 1613 in the first direction (_Y-direction). The end regions 1612a and 1613a may be substantially parallel to the first breakable region 1611.

Referring to FIG. 6B, the breakable portion 161 of the protective film 160 may have a modified shape of the letter “X”. For example, the breakable portion 161 may have a fourth breakable region 1614a and a fifth breakable region 1614b, intersecting each other at a specified angle. The breakable portion 161 may have a plurality of end regions 1615a, 1615b respectively extending from opposite ends of the fourth breakable region 1614a and opposite ends of the fifth breakable region 1614b in the longitudinal direction (Y-axis direction) of the case 120.

Referring to FIG. 6C, at least a portion of the breakable portion 161 of the protective film 160 may have a modified shape of the letter “Y.”

For example, the breakable portion 161 may have a first breakable region 1611 extending in a longitudinal direction (Y-axis direction) of a case (for example, the case 120 in FIG. 1), sixth breakable regions 1616a and 1616b extending from one end of the first breakable region 1611 in different directions, and seventh breakable regions 1617a and 1617b extending from the other end of the first breakable region 1611 in different directions. The first breakable region 1611 and each of the sixth breakable regions 1616a and 1616b may be formed to be inclined at a specified angle with respect to each other. The first breakable region 1611 and each of the seventh breakable regions 1617a and 1617b may be formed to be inclined at a specified angle with respect to each other.

A shape of the breakable portion 161 is not limited to the structure illustrated in FIGS. 4, 5, and/or 6. For example, the breakable portion 161 may be selectively designed based on a structure of the venting portion 130.

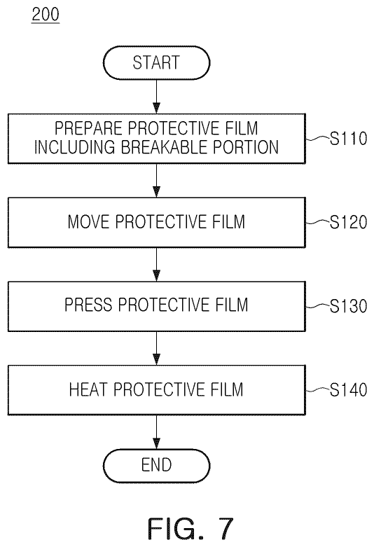

FIG. 7 is a flowchart of a method 200 of manufacturing a battery cell, according to an embodiment.

Referring to FIG. 7, the method 200 of manufacturing a battery cell (for example, the battery cell 100 in FIG. 1) may include an operation (S110) of preparing a protective film (for example, the protective film 160 in FIG. 5) including a breakable portion (for example the breakable portion 161 in FIG. 5), an operation (S120) of moving the protective film 160, an operation (S130) of pressing the protective film 160, and/or an operation (S140) of heating the protective film 160. The battery cell manufacturing method 200 in FIG. 7 may be a method of manufacturing the battery cell 100 illustrated in FIGS. 1 to 3.

According to an embodiment, the operation (S110) of preparing the protective film 160 including the breakable portion 161 may further include an operation of forming the breakable portion 161 in the protective film 160.

According to an embodiment, the operation (S120) of moving the protective film 160 may include an operation of transferring the protective film 160 such that a cover region (for example, the cover region 162 in FIG. 2) of the protective film 160 covers a venting portion 130. For example, the protective film 160 may be moved onto the venting portion 130 using a jig (for example, a jig including a suctioning pad) and/or a gripper. According to an embodiment, the operation (S120) of moving the protective film 160 may be an operation of moving the protective film 160 to a first side surface 120a of a case (for example, the case 120 in FIG. 1) such that the breakable portion 161 opposes a venting portion (for example, the venting portion 130 in FIG. 1) of the case 120.

According to an embodiment, the operation (S130) of pressing the protective film 160 may be an operation of providing pressure to the protective film 160 using a roller and/or a pressing device.

According to an embodiment, the operation (S130) of pressing the protective film 160 may include a rolling operation of partially and/or the stepwise pressing protective film 160 to attach and/or adhere the protective film 160. For example, the operation (S130) of pressing the protective film 160 may include a first rolling operation of pressing the protective film 160, overlapping the venting portion 130, in a width direction (for example, the X-axis direction in FIG. 1) of a case (for example the case in FIG. 1), using a roller. The operation (S130) of pressing the protective film 160 may include, after the first rolling operation, a second rolling operation of pressing the protective film 160, positioned on the case 120, in a longitudinal direction (for example, the Y-axis direction in FIG. 1) of the case 120, using the roller. The operation (S130) of pressing the protective film 160 may include, after the second rolling operation, a third rolling operation of pressing the protective film 160, positioned on the case 120, without overlapping the venting portion 130 in the width direction (for example, the X-axis direction in FIG. 1) of the case 120, using the roller. The protective film 160 may be stepwise pressed, thereby increasing adhesion of the protective film 160 to the case 120 and/or the venting portion 130.

According to an embodiment, the adhesion of the protective film 160 may be increased by performing an operation (S140) of heating the protective film 160. For example, at least a portion of an overlapping portion of the protective film 160 may be melted by heating to prevent detachment of the protective film 160 or reduce a degree of detachment of the protective film 160.

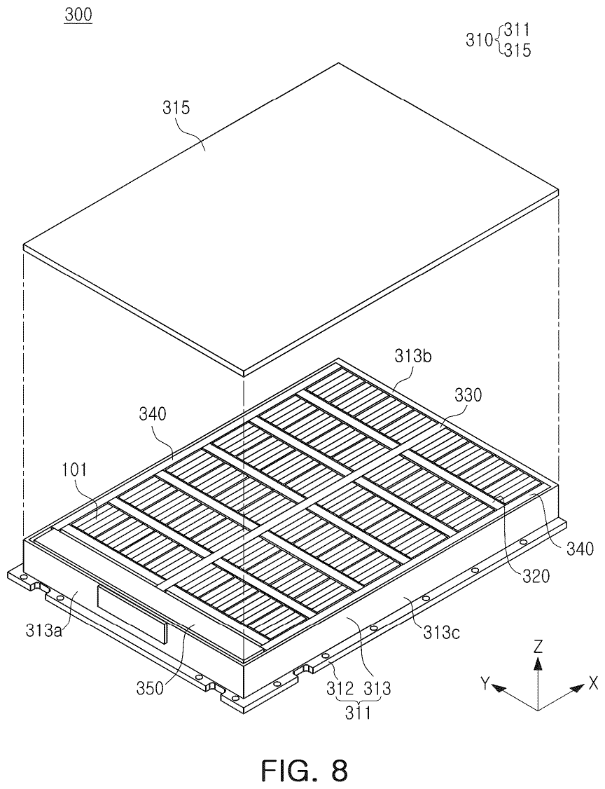

FIG. 8 is an exploded perspective view of a battery device, according to an embodiment.

Referring to FIG. 8, a battery device 300 according to an embodiment may include at least one cell stack 101 and a frame 310. The battery device 300 may refer to a battery pack or battery module.

The cell stack 101 may include a plurality of stacked battery cells (for example, the battery cells 100 in FIG. 1). A direction in which the battery cells 100 are stacked may be selectively designed. The plurality of battery cells 100, connected to the cell stack 101, may be electrically connected to each other using a bus bar (not illustrated).

The frame 310 may accommodate the at least one cell stack 101. For example, the frame 310 may form an accommodation space for accommodating the cell stack 101. In an embodiment, frame 310 may be referred to as a pack case or module case.

The frame 310 may include a bottom member 312 supporting a bottom surface of the cell stack 101, a cover member 315 covering an upper surface of the cell stack 101, and a sidewall member 313 connecting the member 312 and the cover member 315 to each other. The bottom member 312 and the sidewall member 313 may be coupled to each other to form a case body 311.

In an embodiment, the bottom member 312 may be formed to have a substantially rectangular shape, and the number of the sidewall members 313 may be four. For example, the sidewall member 313 may include a front wall 313a positioned in front of the frame 310, a rear wall 313b positioned behind the frame 310, and two sidewalls 313c connecting the front wall 313a and the rear wall 313b to each other.

When a plurality of cell stacks 101 are accommodated in the frame 310, a plurality of accommodation spaces, mutually partitioned, may be formed in the frame 310. The accommodation space of the frame 310 may be partitioned by one or more crossmembers 320 and 330. In an embodiment, at least one of the crossmembers 320 and 330 may be used as a duct member.

In an embodiment, battery device 300 may include a connection duct 340. The connection duct 340 may provide a path for discharging gas flowing through the crossmembers 320 and 330 to the outside of the frame 310.

In an embodiment, the battery device 300 may include a battery controller 350 to control an operation of a battery cell (for example, the battery cell 100 in FIG. 1). The battery controller 350 may include a battery management system (BMS). The battery controller 350 may be disposed in the frame 310.

Only specific examples of implementations of certain embodiments are described. Variations, improvements and enhancements of the disclosed embodiments and other embodiments may be made based on the disclosure of this patent document. For example, the present disclosure may be implemented by deleting some components from the above-described embodiments, and respective embodiments may be implemented in combination with each other.

The features described above are merely examples of the application of the principles of the present disclosure, and other components may be included without departing from the scope of the present disclosure.

What is claimed is:

1. A battery cell comprising:
an electrode assembly;
a case accommodating the electrode assembly;
a venting portion coupled to the case, the venting portion configured to provide an exhaust path for gas generated in the electrode assembly; and
a protective film attached to the case, the protective film configured to cover at least a portion of the venting portion,
wherein the protective film includes a breakable portion including a plurality of recess regions spaced apart from each other.

2. The battery cell of claim 1, wherein the venting portion includes a base coupled to the case, and a notch portion formed on the base, the notch portion configured to break at a specified pressure or higher.

3. The battery cell of claim 2, wherein the plurality of recess regions oppose at least a portion of the notch portion.

4. The battery cell of claim 1, wherein the breakable portion is configured to break due to the gas.

5. The battery cell of claim 1, wherein
the breakable portion has a non-cutting region positioned between the plurality of recess regions, and
a first length of the recessed region is greater than a second length of the non-cutting region.

6. The battery cell of claim 1, wherein
the case includes a first opening oriented in a first direction, and a second opening oriented in a second direction, opposite to the first direction,
the battery cell further includes:
a first cap assembly sealing the first opening, the first cap assembly including a first electrode terminal connected to a cathode of the electrode assembly; and
a second cap assembly sealing the second opening, the second cap assembly including a second electrode terminal connected to an anode of the electrode assembly.

7. The battery cell of claim 6, wherein the venting portion is positioned between the first cap assembly and the second cap assembly.

8. The battery cell of claim 6, wherein
the case has a first side surface and a second side surface having a width, greater than that of the first surface, and
at least a portion of the venting portion is disposed in a through-hole formed in the first side surface.

9. The battery cell of claim 1, wherein the protective film includes an insulating tape.

10. The battery cell of claim 1, wherein the breakable portion has:
a first breakable region extending in a longitudinal direction of the case;
a second breakable region extending from one end of the first breakable region in a width direction of the case; and
a third breakable region extending from the other end of the first breakable region in the width direction of the case.

11. The battery cell of claim 10, wherein the breakable portion has:
a first end region extending from opposite ends of the second breakable region in a second direction, parallel to the longitudinal direction of the case; and
a second end region extending from opposite ends of the third breakable region in a first direction, opposite to the second direction.

12. The battery cell of claim 1, wherein the plurality of recess regions are arranged to have a shape of a dotted line or dashed line.

13. A battery device comprising:
a battery cell; and
a frame accommodating the battery cell,
wherein the battery cell includes:
an electrode assembly;
a case accommodating the electrode assembly;
a venting portion coupled to the case, the venting portion configured to provide an exhaust path for gas generated in the electrode assembly; and
a protective film attached to the case, the protective film configured to cover at least a portion of the venting portion, and
the protective film includes a breakable portion including a plurality of recess regions spaced apart from each other.

14. A method of manufacturing a battery device, the method comprising:
an operation of preparing a protective film including a breakable portion;
an operation of moving the protective film onto a case of the battery cell;
an operation of pressing the protective film; and
an operation of heating the protective film.

15. The method of claim 14, wherein the operation of moving the protective film is configured to move the protective film such that the breakable portion opposes at least a portion of a notch portion formed in a venting portion of the battery cell.

16. The method of claim 15, wherein the operation of pressing the protective film includes:
a first rolling operation of pressing a portion of the protective film, opposing the venting portion of the battery cell, in a width direction of the case;
a second rolling operation of pressing a portion of the protective film, opposing the venting portion of the battery cell, in a longitudinal direction of the case; and
a third rolling operation of pressing another portion of the protective film, disposed on the case without opposing the venting portion of the battery cell, in the width direction of the case.
